(19) United States
(12) Patent Application Publication
(10) Pub. No.: US 2022/0216564 A1
(43) Pub. Date: Jul. 7, 2022

(54) SECONDARY BATTERY

(71) Applicant: MURATA MANUFACTURING CO., LTD., Kyoto (JP)

(72) Inventors: Taichi KOGURE, Kyoto (JP); Akira ICHIHASHI, Kyoto (JP); Takahiro YUUKI, Kyoto (JP); Masahiro MIYAMOTO, Kyoto (JP); Fumihito ISHII, Kyoto (JP)

(21) Appl. No.: 17/704,484

(22) Filed: Mar. 25, 2022

Related U.S. Application Data
(63) Continuation of application No. PCT/JP2020/033530, filed on Sep. 4, 2020.

(30) Foreign Application Priority Data
Sep. 30, 2019 (JP) 2019-178787

(51) Int. Cl. H01M 50/298; H01M 10/0525; H01M 10/0587

(52) U.S. Cl. CPC H01M 50/298; H01M 10/0587; H01M 10/0525

(57) ABSTRACT

A secondary battery includes an outer package member with flexibility, a battery device, a first wiring member, second wiring members, and a first insulating member. The battery device is accommodated inside the outer package member. The first wiring member extends from an inside to an outside of the outer package member and includes an opposed part opposing to the battery device. The opposed part includes an opposed surface, an opposite surface, and a side surface. The opposed surface is opposed to the battery device. The opposite surface is provided on an opposite side to the opposed surface. The side surface is coupled to the opposed surface and the opposite surface. The second wiring members are disposed inside the outer package member. Each of the second wiring members has a first end coupled to the battery device and a second end coupled to the opposed part at the opposite surface.

### CROSS REFERENCE TO RELATED APPLICATIONS

The present application is a continuation of PCT patent application no. PCT/JP2020/033530, filed on Sep. 4, 2020, which claims priority to Japanese patent application no. JP2019-178787 filed on Sep. 30, 2019, the entire contents of which are being incorporated herein by reference.

### BACKGROUND

The present technology generally relates to a secondary battery.

Various kinds of electronic equipment, including mobile phones, have been widely used. Such widespread use has promoted development of a secondary battery as a power source that is smaller in size and lighter in weight and allows for a higher energy density. A configuration of the secondary battery influences a battery characteristic and has therefore been considered in various ways.

Specifically, in order to decrease an electric coupling resistance, a plurality of positive electrode leads and a plurality of negative electrode leads are used. In order to improve a charge and discharge cyclability life under a heavy load condition, a negative electrode is provided with a plurality of lead terminals. In order to prevent a short circuit, etc., a positive electrode lead and a negative electrode lead are each provided with an insulating cover. Other than the above, in order to achieve various purposes in a secondary battery including an outer package member such as a laminated film, a configuration such as a shape of a tab, a shape of a lead, or a sealing structure is made appropriate.

### SUMMARY

The present technology generally relates to a secondary battery.

Although consideration has been given in various ways to solve problems of a secondary battery, the secondary battery has not yet achieved sufficient reliability related to a wiring structure inside the secondary battery, and there is still room for improvement in terms thereof.

The present technology has been made in view of such an issue and it is an object of the technology to provide a secondary battery that makes it possible to secure higher reliability related to a wiring structure inside thereof.

A secondary battery according to an embodiment of the present technology includes an outer package member, a battery device, a first wiring member, second wiring members, and a first insulating member. The outer package member has flexibility. The battery device is accommodated inside the outer package member. The first wiring member extends from an inside to an outside of the outer package member and includes an opposed part opposed to the battery device. The opposed part includes an opposed surface, an opposite surface, and a side surface. The opposed surface is opposed to the battery device. The opposite surface is provided on an opposite side to the opposed surface. The side surface is coupled to the opposed surface and the opposite surface. The second wiring members are disposed inside the outer package member. Each of the second wiring members has a first end coupled to the battery device and a second end coupled to the opposed part at the opposite surface. A portion of each of the second wiring members is bent to lie along the opposed surface, the side surface, and the opposite surface in this order. The first insulating member is disposed to lie along the opposed surface between the opposed part and a portion of the second wiring members.

According to the secondary battery of an embodiment of the present technology, the battery device is accommodated inside the outer package member having flexibility. The first wiring member extending from the inside to the outside of the outer package member includes the opposed part opposed to the battery device, and the opposed part includes the opposed surface, the side surface, and a non-opposed surface. The second wiring members are disposed inside the outer package member, and each of the second wiring members has the first end coupled to the battery device and the second end coupled to the opposed part at the opposite surface. A portion of each of the second wiring members is bent to lie along the opposed surface, the side surface, and the opposite surface in this order, and the first insulating member is disposed to lie along the opposed surface between the opposed part and a portion of the second wiring members. Accordingly, it is possible to secure higher reliability related to the wiring structure inside the secondary battery.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery according to an embodiment of the present technology.

FIG. 2 is a perspective view of a configuration of a battery device illustrated in FIG. 1.

FIG. 3 is a sectional view of respective configurations of a positive electrode and a negative electrode according to an embodiment of the present technology.

FIG. 4 is a sectional view of the configuration of the secondary battery illustrated in FIG. 1.

FIG. 5 is another sectional view of the configuration of the secondary battery illustrated in FIG. 1.

FIG. 6 is a sectional diagram for describing a manufacturing process of the secondary battery according to an embodiment of the present technology.

FIG. 7 is another sectional diagram for describing the manufacturing process of the secondary battery according to an embodiment of the present technology.

FIG. 8 is a sectional view of a configuration of a secondary battery of a first comparative example.

FIG. 9 is a sectional view of a configuration of a secondary battery of a second comparative example.

FIG. 10 is a block diagram illustrating a configuration of an application example of the secondary battery according to an embodiment, which is a battery pack including a single battery.

FIG. 11 is a block diagram illustrating a configuration of an application example of the secondary battery according to an embodiment, which is a battery pack including an assembled battery.

FIG. 12 is a block diagram illustrating a configuration of an application example of the secondary battery according to an embodiment, which is an electric vehicle.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited in kind, the electrode reactant is a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

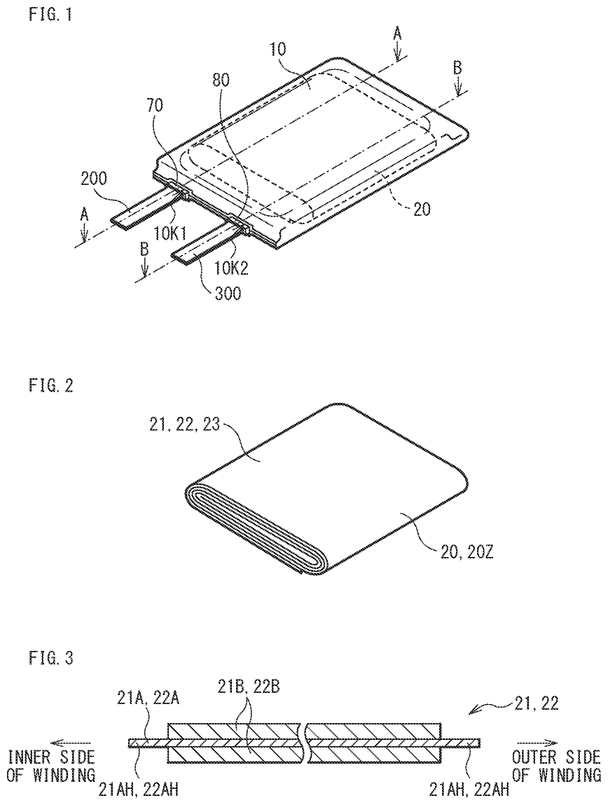

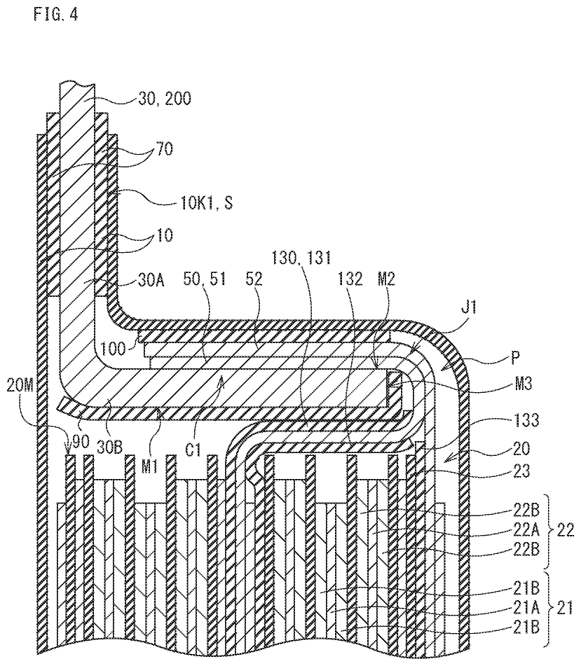

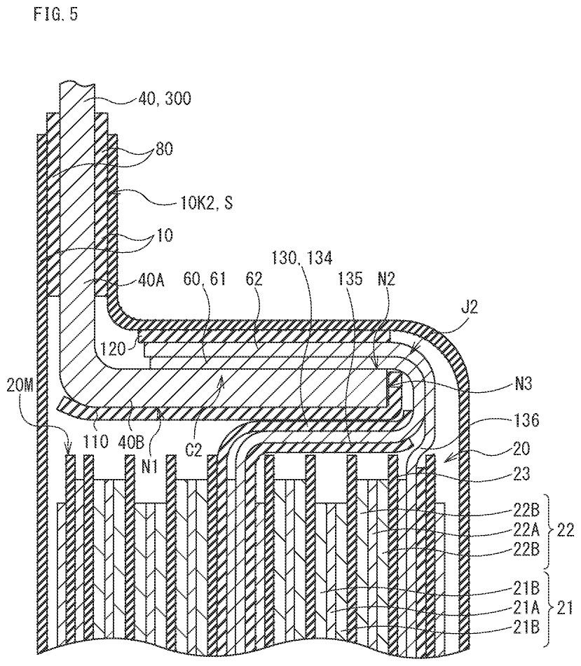

FIG. 1 illustrates a perspective configuration of the secondary battery. FIG. 2 illustrates a perspective configuration of a battery device 20 illustrated in FIG. 1. FIG. 3 illustrates respective sectional configurations of a positive electrode 21 and a negative electrode 22. FIGS. 4 and 5 each illustrate a sectional configuration of the secondary battery illustrated in FIG. 1. It should be understood that in FIG. 3, the positive electrode 21 and the negative electrode 22 are illustrated together because the positive electrode 21 and the negative electrode 22 have a common configuration. FIG. 4 illustrates a section taken along a line A-A. FIG. 5 illustrates a section taken along a line B-B.

In the following description, a vertical direction in FIGS. 4 and 5 is regarded as a height direction of the secondary battery, and a horizontal direction in FIGS. 4 and 5 is regarded as a width direction of the secondary battery. Further, in the height direction of the secondary battery, an up direction in FIGS. 4 and 5 is regarded as an upper side of the secondary battery, and a down direction in FIGS. 4 and 5 is regarded as a lower side of the secondary battery.

As illustrated in FIGS. 1 to 5, the secondary battery includes an outer package film 10, the battery device 20, a positive electrode wiring line 200, a negative electrode wiring line 300, a positive electrode sealant 70, a negative electrode sealant 80, positive electrode insulating tapes 90 and 100, negative electrode insulating tapes 110 and 120, and an auxiliary insulating tape 130. The positive electrode wiring line 200 includes a positive electrode lead 30 and positive electrode tabs 50. The negative electrode wiring line 300 includes a negative electrode lead 40 and negative electrode tabs 60.

In the secondary battery, the battery device 20 is contained inside the outer package film 10. The positive electrode wiring line 200 and the negative electrode wiring line 300 are coupled to the battery device 20. The positive electrode wiring line 200 and the negative electrode wiring line 300 are led out in a common direction from an inside to an outside of the outer package film 10.

In other words, the secondary battery described here is a secondary battery of a laminated-film type in which the outer package film 10 is used as an outer package member to contain the battery device 20. Here, the secondary battery has a flat three-dimensional shape.

The outer package film 10 is an outer package member having flexibility or softness. More specifically, as illustrated in FIGS. 1, 3, and 4, the outer package film 10 is a member having a hollow pouch shape. The outer package film 10 includes one or more of materials including, without limitation, a polymer material and a metal material.

Specifically, the outer package film 10 is a three-layer laminated film including a fusion-bonding layer, a metal layer, and a surface protective layer that are stacked in this order from an inner side. The fusion-bonding layer is a polymer film including a polymer material such as polypropylene, and is fusion-bondable by a method such as a thermal fusion bonding method. The metal layer is a metal foil including a metal material such as aluminum. The surface protective layer is a polymer film including a polymer material such as nylon. The number of layers of the outer package film 10 as a laminated film is not particularly limited, and may be two, or four or more. It goes without saying that the outer package film 10 is not limited to a multilayer film, and may be a single-layer film.

The outer package film 10 has an opening 10K1 through which the positive electrode wiring line 200 is to be led out and an opening 10K2 through which the negative electrode wiring line 300 is to be led out. The opening 10K1 is sealed by means of the positive electrode sealant 70 in a state where the positive electrode wiring line 200 is led out to the outside of the outer package film 10 via the opening 10K1, as will be described later. In addition, the opening 10K2 is sealed by means of the negative electrode sealant 80 in a state where the negative electrode wiring line 300 is led out to the outside of the outer package film 10 via the opening 10K2, as will be described later.

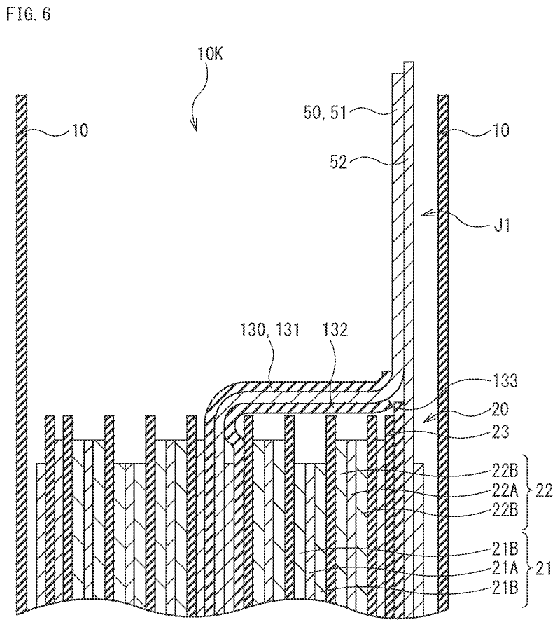

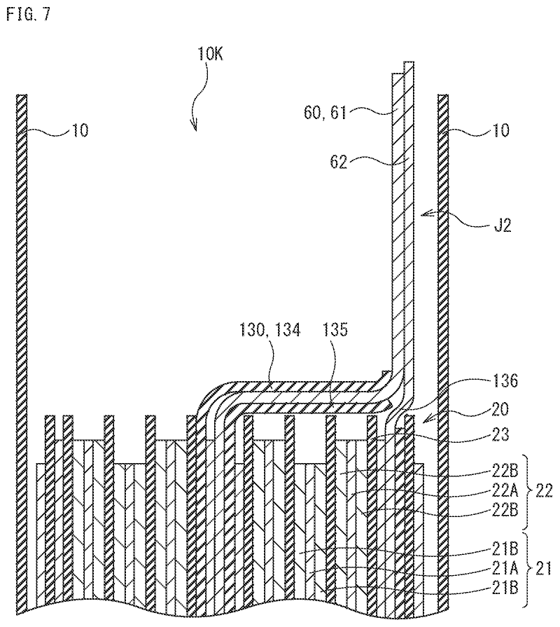

It should be understood that the outer package film 10 is formed by sealing an opening 10K, which will be described later with reference to FIGS. 6 and 7, in a state where the positive electrode wiring line 200 and the negative electrode wiring line 300 are each led out via the opening 10K. Specifically, in a manufacturing process of the secondary battery, portions of the outer package film 10 opposed to each other at the opening 10K are joined to each other with the positive electrode wiring line 200, the negative electrode wiring line 300, the positive electrode sealant 70, and the negative electrode sealant 80 interposed therebetween, to thereby seal the outer package film 10 except for the openings 10K1 and 10K2. As a result, the outer package film 10 has a seal part S at which the opening 10K is sealed.

The battery device 20 is a device causing charging and discharging reactions to proceed. As illustrated in FIGS. 2 to 5, the battery device 20 is contained inside the outer package film 10. The battery device 20 includes the positive electrode 21, the negative electrode 22, a separator 23, and an electrolytic solution which is a liquid electrolyte. It should be understood that FIGS. 2 to 5 each omit the illustration of the electrolytic solution.

The positive electrode 21 and the negative electrode 22 are wound with the separator 23 interposed therebetween. More specifically, the positive electrode 21 and the negative electrode 22 are stacked on each other with the separator 23 interposed therebetween, and are wound in the state of the stack with the separator 23 interposed between the positive electrode 21 and the negative electrode 22. Thus, the battery device 20 is a wound electrode body including the positive electrode 21 and the negative electrode 22 that are wound with the separator 23 interposed therebetween. The respective numbers of winds of the positive electrode 21, the negative electrode 22, and the separator 23 are not particularly limited, and may be freely chosen.

It should be understood that the positive electrode 21 has a height smaller than that of the separator 23. A reason for this is that this prevents a short circuit caused by the positive electrode 21. The negative electrode 22 has a height smaller than that of the separator 23 and larger than that of the positive electrode 21. A reason for this is that this prevents a short circuit caused by the negative electrode 22 and also prevents a short circuit between the positive electrode 21 and the negative electrode 22 caused by precipitation of lithium upon charging and discharging.

The positive electrode 21 is an electrode included in the battery device 20. The positive electrode 21 includes a positive electrode current collector 21A (a current collector) and a positive electrode active material layer 21B (an active material layer). The positive electrode current collector 21A is a metal foil including a metal material such as aluminum. The positive electrode active material layer 21B is provided on each of opposite sides of the positive electrode current collector 21A. It should be understood that the positive electrode active material layer 21B may be provided only on one side of the positive electrode current collector 21A. The positive electrode active material layer 21B includes a positive electrode active material into which lithium is insertable and from which lithium is extractable. The positive electrode active material includes one or more of lithium-containing compounds including, without limitation, a lithium-containing transition metal compound. Examples of the lithium-containing transition metal compound include an oxide, a phosphoric acid compound, a silicic acid compound, and a boric acid compound each including lithium and one or more transition metal elements as constituent elements. It should be understood that the positive electrode active material layer 21B may further include, for example, a positive electrode binder and a positive electrode conductor.

The negative electrode 22 is another electrode included in the battery device 20. The negative electrode 22 includes a negative electrode current collector 22A (another current collector) and a negative electrode active material layer 22B (another active material layer). The negative electrode current collector 22A is a metal foil including a metal material such as copper. The negative electrode active material layer 22B is provided on each of opposite sides of the negative electrode current collector 22A. It should be understood that the negative electrode active material layer 22B may be provided only on one side of the negative electrode current collector 22A. The negative electrode active material layer 22B includes a negative electrode active material into which lithium is insertable and from which lithium is extractable. The negative electrode active material includes one or more of materials including, without limitation, a carbon material and a metal-based material. Examples of the carbon material include graphite. The metal-based material is a material that includes, as a constituent element or constituent elements, one or more elements among metal elements and metalloid elements that are each able to form an alloy with lithium. Specifically, the metal-based material includes one or more of elements including, without limitation, silicon and tin. The metal-based material may be a simple substance, an alloy, a compound, or a mixture of two or more thereof. It should be understood that the negative electrode active material layer 22B may further include, for example, a negative electrode binder and a negative electrode conductor.

The separator 23 is an insulating porous film interposed between the positive electrode 21 and the negative electrode 22. The separator 23 allows lithium to pass therethrough while preventing a short circuit between the positive electrode 21 and the negative electrode 22. This separator 23 includes one or more of polymer materials including, without limitation, polyethylene.

The positive electrode 21, the negative electrode 22, and the separator 23 are each impregnated with the electrolytic solution. The electrolytic solution includes a solvent and an electrolyte salt. The solvent includes one or more of nonaqueous solvents (organic solvents) including, without limitation, a carbonic-acid-ester-based compound, a carboxylic-acid-ester-based compound, and a lactone-based compound. The electrolyte salt includes one or more of light metal salts including, without limitation, a lithium salt.

In the battery device 20 which is the wound electrode body, the positive electrode active material layer 21B is provided on a portion of the positive electrode current collector 21A, and the negative electrode active material layer 22B is provided on a portion of the negative electrode current collector 22A.

Specifically, at each of ends of the positive electrode 21 on an inner side and an outer side of winding, the positive electrode active material layer 21B is not provided on the positive electrode current collector 21A, and the positive electrode current collector 21A thus has exposed parts 21AH at respective opposite ends. Accordingly, the positive electrode 21 has a foil winding structure in which only the positive electrode current collector 21A is wound at each of the ends on the inner side and the outer side of the winding.

Similarly, at each of ends of the negative electrode 22 on the inner side and the outer side of the winding, the negative electrode active material layer 22B is not provided on the negative electrode current collector 22A, and the negative electrode current collector 22A thus has exposed parts 22AH at respective opposite ends. Accordingly, the negative electrode 22 has a foil winding structure in which only the negative electrode current collector 22A is wound at each of the ends on the inner side and the outer side of the winding.

It should be understood that FIG. 2 also illustrates a wound body 20Z to be used to fabricate the battery device 20 in the manufacturing process of the secondary battery to be described later. The wound body 20Z has a configuration similar to that of the battery device 20 which is the wound electrode body, except that the positive electrode 21, the negative electrode 22, and the separator 23 are each yet to be impregnated with the electrolytic solution.

The positive electrode wiring line 200 extends from the inside of the outer package film 10 to the outside of the outer package film 10 via the opening 10K1, and is coupled to the positive electrode 21 of the battery device 20. The negative electrode wiring line 300 extends from the inside of the outer package film 10 to the outside of the outer package film 10 via the opening 10K2, and is coupled to the negative electrode 22 of the battery device 20.

As illustrated in FIGS. 1 and 4, the positive electrode lead 30 is a first wiring member that extends from the inside of the outer package film 10 to the outside of the outer package film 10 via the opening 10K1.

One end of the positive electrode lead 30 is coupled to another end of each of the positive electrode tabs 50 inside the outer package film 10. Here, the one end of the positive electrode lead 30 is coupled to a joint part J1, which will be described later, to thereby form a coupling part C1. The coupling part C1 is a part at which the positive electrode lead 30 and the joint part J1 are coupled to each other by a method such as a welding method. Another end of the positive electrode lead 30 is led out to the outside of the outer package film 10.

Here, inside the outer package film 10, the positive electrode lead 30 is bent in a direction intersecting with a direction in which the positive electrode lead 30 is led out from the outer package film 10, i.e., is bent in a horizontal direction in FIG. 4 intersecting with a vertical direction in FIG. 4. The positive electrode lead 30 thus includes lead parts 30A and 30B.

The lead part 30A is a part that extends from the inside of the outer package film 10 to the outside of the outer package film 10 via the opening 10K1. The lead part 30B is an opposed part that extends in a direction intersecting with a direction in which the lead part 30A extends, while being opposed to the battery device 20 inside the outer package film 10. The lead part 30B is coupled to the lead part 30A.

The lead part 30B includes a lower surface M1, an upper surface M2, and a side surface M3. The lower surface M1 is a surface with which the lead part 30B is opposed to the battery device 20, i.e., is an opposed surface. The upper surface M2 is a surface provided on an opposite side to the lower surface M1, i.e., is an opposite surface. The side surface M3 is a surface positioned between the lower surface M1 and the upper surface M2 and coupled to both the lower surface M1 and the upper surface M2.

It should be understood that, as long as the lead part 30B is opposed to the battery device 20, the lower surface M1 of the lead part 30B may be parallel to an upper surface 20M of the battery device 20, or may be inclined with respect to the upper surface 20M. The angle at which the lower surface M1 is inclined with respect to the upper surface 20M is not particularly limited as long as the angle secures the opposed relationship between the lead part 30B and the battery device 20.

The positive electrode lead 30 includes a material similar to a material included in the positive electrode current collector 21A. It should be understood that the material included in the positive electrode lead 30 may be the same as or different from the material included in the positive electrode current collector 21A.

The negative electrode lead 40 has a configuration similar to the configuration of the positive electrode lead 30 described above. That is, as illustrated in FIG. 5, the negative electrode lead 40 is another first wiring member that extends from the inside of the outer package film 10 to the outside of the outer package film 10 via the opening 10K2.

One end of the negative electrode lead 40 is coupled to another end of each of the negative electrode tabs 60 inside the outer package film 10. Here, the one end of the negative electrode lead 40 is coupled to a joint part J2, which will be described later, to thereby form a coupling part C2. The coupling part C2 is a part at which the negative electrode lead 40 and the joint part J2 are coupled to each other by a method such as a welding method. Another end of the negative electrode lead 40 is led out to the outside of the outer package film 10.

Here, inside the outer package film 10, the negative electrode lead 40 is bent in a direction intersecting with a direction in which the negative electrode lead 40 is led out from the outer package film 10, i.e., is bent in a horizontal direction in FIG. 5 intersecting with a vertical direction in FIG. 5. The negative electrode lead 40 thus includes lead parts 40A and 40B.

The lead part 40A is a part that extends from the inside of the outer package film 10 to the outside of the outer package film 10 via the opening 10K2. The lead part 40B is another opposed part that extends in a direction intersecting with a direction in which the lead part 40A extends, while being opposed to the battery device 20 inside the outer package film 10. The lead part 40B is coupled to the lead part 40A.

The lead part 40B includes a lower surface N1, an upper surface N2, and a side surface N3. The lower surface N1 is a surface with which the lead part 40B is opposed to the battery device 20, i.e., is another opposed surface. The upper surface N2 is a surface provided on an opposite side to the lower surface N1, i.e., is another opposite surface. The side surface N3 is a surface positioned between the lower surface N1 and the upper surface N2 and coupled to both the lower surface N1 and the upper surface N2.

It should be understood that, as long as the lead part 40B is opposed to the battery device 20, the lower surface N1 of the lead part 40B may be parallel to the upper surface 20M of the battery device 20, or may be inclined with respect to the upper surface 20M. The angle at which the lower surface N1 is inclined with respect to the upper surface 20M is not particularly limited as long as the angle secures the opposed relationship between the lead part 40B and the battery device 20.

The negative electrode lead 40 includes a material similar to a material included in the negative electrode current collector 22A. It should be understood that the material included in the negative electrode lead 40 may be the same as or different from the material included in the negative electrode current collector 22A.

As illustrated in FIG. 4, the positive electrode tabs 50 are second wiring members disposed inside the outer package film 10. A reason why the positive electrode tabs 50 are plural in number is that this allows for a decrease in electric resistance (electric coupling resistance) of the battery device 20 (the positive electrode 21).

The secondary battery described here includes two positive electrode tabs 50, i.e., positive electrode tabs 51 and 52, which are the minimum number of positive electrode tabs 50.

A reason for this is that the electric resistance of the battery device 20 decreases as described above, as compared to a case where the number of the positive electrode tabs 50 is one. Another reason is that, in a case where the number of the positive electrode leads 30 is set to two or more, the positive electrode leads 30 have to be led out from the outer package film 10 to the outside separately from each other, or have to be led out from the outer package film 10 to the outside while being stacked on each other, which results in an increase in the number of the seal parts S or complication of a sealing structure of the seal part S. This causes reliability of the seal part S to be lowered easily.

The number of the positive electrode tabs 50 is not particularly limited and is therefore freely chosen. However, in order to decrease the electric resistance of the battery device 20 and to reduce volume loss related to an inner space of the outer package film 10, the number of the positive electrode tabs 50 is preferably three or less, and more preferably two or less. In addition, in order to reduce the above-described volume loss, the thickness of the positive electrode tabs 50 is preferably smaller than the thickness of the positive electrode lead 30.

One end of each of the positive electrode tabs 51 and 52 is coupled to the battery device 20, more specifically, to the positive electrode 21 (the positive electrode current collector 21A). Another end of the positive electrode tab 51 and another end of the positive electrode tab 52 are in contact with each other. Here, the positive electrode tabs 51 and 52 are joined to each other, to thereby form the joint part J1. The joint part J1 is a part at which the other end of the positive electrode tab 51 and the other end of the positive electrode tab 52 are joined to each other by a method such as a welding method.

The joint part J1 is coupled to the one end of the positive electrode lead 30 to thereby form the coupling part C1, as described above. Here, the positive electrode lead 30 includes the lead part 30B inside the outer package film 10 as described above, and accordingly, the joint part J1 is coupled to the lead part 30B. In this case, the joint part J1 is coupled to the lead part 30B at the upper surface M2.

In order to form the coupling part C1, a portion of the positive electrode tabs 51 and 52, i.e., the positive electrode tab 51, is bent to lie along a surface of the lead part 30B. Specifically, the positive electrode tab 51 is bent to lie along the lower surface Ml, the side surface M3, and the upper surface M2 in this order. The joint part J1 is thus coupled to the lead part 30B at the upper surface M2, as described above.

Each of the positive electrode tabs 51 and 52 includes a material similar to the material included in the positive electrode current collector 21A. It should be understood that the material included in each of the positive electrode tabs 51 and 52 may be the same as or different from the material included in the positive electrode current collector 21A.

A position of coupling between each of the positive electrode tabs 51 and 52 and the positive electrode 21 is not particularly limited. Here, because the positive electrode 21 is wound in the battery device 20 which is the wound electrode body, the positive electrode tab 51 is coupled to the end (the exposed part 21AH) of the positive electrode 21 on the inner side of the winding, and the positive electrode tab 52 is coupled to the end (the exposed part 21AH) of the positive electrode 21 on the outer side of the winding. In other words, because the positive electrode 21 has the foil winding structure, as described above, each of the positive electrode tabs 51 and 52 is coupled to the positive electrode current collector 21A. A reason for this is that this allows an electric coupling characteristic obtained with use of the positive electrode current collector 21A to be uniform, making it easier for the charging and discharging reactions to proceed uniformly in the positive electrode 21.

In this case, the positive electrode tabs 51 and 52 are preferably coupled to the positive electrode current collector 21A (the respective exposed parts 21AH) at respective positions symmetrical with respect to the center of the positive electrode current collector 21A in the extending direction of the positive electrode current collector 21A illustrated in FIG. 3. In other words, a distance from the center position of the positive electrode current collector 21A in the extending direction thereof to the position of coupling between the positive electrode tab 51 and the positive electrode current collector 21A and a distance from the above-described center position of the positive electrode current collector 21A to the position of coupling between the positive electrode tab 52 and the positive electrode current collector 21A are preferably substantially equal. A reason for this is that this allows the electric coupling characteristic obtained with use of the positive electrode current collector 21A to be more uniform.

Although the positive electrode tab 52 is coupled to the positive electrode current collector 21A (the exposed part 21AH) on the right side in FIG. 4 here, the position at which the positive electrode tab 52 is coupled to the positive electrode current collector 21A is not particularly limited. For example, the positive electrode tab 52 may be coupled to the positive electrode current collector 21A on the left side in FIG. 4. However, in order to allow the length of the positive electrode tab 52 to be short, the positive electrode tab 52 is preferably coupled to the positive electrode current collector 21A on the right side in FIG. 4, i.e., on a side closer to a side to which the positive electrode tab 51 is bent.

The negative electrode tabs 60 have a configuration similar to the configuration of the positive electrode tabs 50 described above. That is, as illustrated in FIG. 5, the negative electrode tabs 60 are other second wiring members disposed inside the outer package film 10. A reason why the negative electrode tabs 60 are plural in number is that this allows for a decrease in electric resistance (electric coupling resistance) of the battery device 20 (the negative electrode 22).

The secondary battery described here includes two negative electrode tabs 60, i.e., negative electrode tabs 61 and 62, which are the minimum number of negative electrode tabs 60. A reason for this is that, in a case where the number of the negative electrode lead 40 is set to two or more, reliability of the seal part S is lowered easily for a reason similar to the reason described above in relation to the two positive electrode tabs 50, i.e., the positive electrode tabs 51 and 52.

The number of the negative electrode tabs 60 is not particularly limited and is therefore freely chosen. However, the number of the negative electrode tabs 60 is preferably three or less, and more preferably two or less, for a reason similar to that described above in relation to the number of the positive electrode tabs 50.

One end of each of the negative electrode tabs 61 and 62 is coupled to the battery device 20, more specifically, to the negative electrode 22 (the negative electrode current collector 22A). Another end of the negative electrode tab 61 and another end of the negative electrode tab 62 are in contact with each other. Here, the negative electrode tabs 61 and 62 are joined to each other, to thereby form the joint part J2. The joint part J2 is a part at which the other end of the negative electrode tab 61 and the other end of the negative electrode tab 62 are joined to each other by a method such as a welding method.

The joint part J2 is coupled to the one end of the negative electrode lead 40 to thereby form the coupling part C2, as described above. Here, the negative electrode lead 40 includes the lead part 40B inside the outer package film 10, as described above, and accordingly, the joint part J2 is coupled to the lead part 40B. In this case, the joint part J2 is coupled to the lead part 40B at the upper surface N2.

In order to form the coupling part C2, a portion of the negative electrode tabs 61 and 62, i.e., the negative electrode tab 61, is bent to lie along a surface of the lead part 40B. Specifically, the negative electrode tab 61 is bent to lie along the lower surface N1, the side surface N3, and the upper surface N2 in this order. The joint part J2 is thus coupled to the lead part 40B at the upper surface N2, as described above.

Each of the negative electrode tabs 61 and 62 includes a material similar to the material included in the negative electrode current collector 22A. It should be understood that the material included in each of the negative electrode tabs 61 and 62 may be the same as or different from the material included in the negative electrode current collector 22A.

A position of coupling between each of the negative electrode tabs 61 and 62 and the negative electrode 22 is not particularly limited. Here, because the negative electrode 22 is wound in the battery device 20 which is the wound electrode body, the negative electrode tab 61 is coupled to the end (the exposed part 22AH) of the negative electrode 22 on the inner side of the winding, and the negative electrode tab 62 is coupled to the end (the exposed part 22AH) of the negative electrode 22 on the outer side of the winding. In other words, because the negative electrode 22 has the foil winding structure, as described above, each of the negative electrode tabs 61 and 62 is coupled to the negative electrode current collector 22A. A reason for this is that this allows an electric coupling characteristic obtained with use of the negative electrode current collector 22A to be uniform, making it easier for the charging and discharging reactions to proceed uniformly in the negative electrode 22.

In this case, the negative electrode tabs 61 and 62 are preferably coupled to the negative electrode current collector 22A (the respective exposed parts 22AH) at respective positions symmetrical with respect to the center of the negative electrode current collector 22A in the extending direction of the negative electrode current collector 22A illustrated in FIG. 3, for a reason similar to the reason described above in relation to the position of coupling between each of the positive electrode tabs 51 and 52 and the positive electrode 21.

Although the negative electrode tab 62 is coupled to the negative electrode current collector 22A (the exposed part 22AH) on the right side in FIG. 5 here, the position at which the negative electrode tab 62 is coupled to the negative electrode current collector 22A is not particularly limited. For example, the negative electrode tab 62 may be coupled to the negative electrode current collector 22A on the left side in FIG. 5, as with the case described above in relation to the positive electrode tab 52. However, in order to allow the length of the negative electrode tab 62 to be short, the negative electrode tab 62 is preferably coupled to the negative electrode current collector 22A on the right side in FIG. 5, i.e., on a side closer to a side to which the negative electrode tab 61 is bent.

As illustrated in FIG. 4, the positive electrode sealant 70 seals the opening 10K1 to thereby prevent entry of outside air into the outer package film 10. The positive electrode sealant 70 is disposed, at the opening 10K1, between the outer package film 10 and the positive electrode lead 30. Here, the positive electrode sealant 70 covers the periphery of the positive electrode lead 30, and therefore has a so-called tube shape. However, a range to provide the positive electrode sealant 70 may be expanded to the outside of the outer package film 10.

The positive electrode sealant 70 includes one or more of insulating materials including, without limitation, a polymer material. Examples of the polymer material include polyolefin having adherence to the positive electrode lead 30. Such a polyolefin is not particularly limited in kind, and examples thereof include polyethylene, polypropylene, modified polyethylene, and modified polypropylene.

In particular, in a case where the outer package film 10 includes the fusion-bonding layer which is thermal-fusion-bondable as described above, the positive electrode sealant 70 preferably includes a polymer compound that is thermal-fusion-bondable as with the fusion-bonding layer, and the outer package film 10 and the positive electrode sealant 70 are therefore preferably thermal-fusion-bonded to each other at the opening 10K1. A reason for this is that this makes it easier to seal the opening 10K1 by utilizing the thermal fusion bonding between the outer package film 10 and the positive electrode sealant 70 even if the positive electrode lead 30 is present at the opening 10K1.

The negative electrode sealant 80 has a configuration similar to the configuration of the positive electrode sealant 70 described above. That is, as illustrated in FIG. 5, the negative electrode sealant 80 seals the opening 10K2 to thereby prevent entry of outside air into the outer package film 10. The negative electrode sealant 80 is disposed, at the opening 10K2, between the outer package film 10 and the negative electrode lead 40. Here, the negative electrode sealant 80 covers the periphery of the negative electrode lead 40, and therefore has a so-called tube shape. However, a range to provide the negative electrode sealant 80 may be expanded to the outside of the outer package film 10.

The negative electrode sealant 80 includes one or more of insulating materials including, without limitation, a polymer material. Examples of the polymer material include polyolefin having adherence to the negative electrode lead 40. Details of the kind of polyolefin are as described above.

In particular, in a case where the outer package film 10 includes the fusion-bonding layer which is thermal-fusion-bondable as described above, the negative electrode sealant 80 preferably includes a polymer compound that is thermal-fusion-bondable as with the fusion-bonding layer, and the outer package film 10 and the negative electrode sealant 80 are therefore preferably thermal-fusion-bonded to each other at the opening 10K2. A reason for this is that this makes it easier to seal the opening 10K2 by utilizing the thermal fusion bonding between the outer package film 10 and the negative electrode sealant 80 even if the negative electrode lead 40 is present at the opening 10K2.

The positive electrode insulating tape 90 is a first insulating member that is disposed inside the outer package film 10, more specifically, is disposed outside the battery device 20.

As illustrated in FIG. 4, the positive electrode insulating tape 90 is disposed to lie along the lower surface M1 between the lead part 30B and a portion of the positive electrode tabs 50, i.e., the positive electrode tab 51 of the positive electrode tabs 51 and 52, and is thus interposed between the coupling part C1 and the battery device 20. The positive electrode insulating tape 90 therefore insulates the coupling part C1 from the battery device 20 (the negative electrode 22) to thereby prevent a short circuit between the coupling part Cl and the battery device 20.

Here, the positive electrode insulating tape 90 is disposed to further lie between the lead part 30B and the battery device 20 along the lower surface M1. The positive electrode insulating tape 90 is thus interposed throughout between the coupling part C1 and the battery device 20, therefore preventing the short circuit between the coupling part C1 and the battery device 20 over a wide range.

Although the positive electrode insulating tape 90 may be disposed to lie along only the lower surface M1, the positive electrode insulating tape 90 is preferably disposed not only to lie along the lower surface M1 but to further lie along the side surface M3, in particular. A reason for this is that this allows a corner of the positive electrode lead 30 (the lead part 30B), i.e., a sharp corner formed by the lower surface M1 and the side surface M3, to be protected by the positive electrode insulating tape 90, and accordingly prevents the positive electrode tab 51 from being damaged by coming into contact with the corner. Examples of the damage to be caused on the positive electrode tab 51 include occurrence of a crack and a breakage.

The positive electrode insulating tape 90 includes one or more of insulating materials including, without limitation, a polymer material. Examples of the polymer material include polyethylene, polyethylene terephthalate, and polyimide.

It should be understood that the positive electrode insulating tape 90 is preferably bonded to the positive electrode lead 30 (the lead part 30B) and also to the positive electrode tab 51. A reason for this is that, because the positive electrode insulating tape 90 is fixed to both the lead part 30B and the positive electrode tab 51, the position of the positive electrode insulating tape 90 is prevented from deviating easily from the original position even if the secondary battery receives an external load due to, for example, vibration or impact. This makes it easier to maintain a state where the positive electrode insulating tape 90 is interposed between the lead part 30B and the positive electrode tab 51, thus preventing a short circuit between the coupling part C1 and the battery device 20 from occurring easily regardless of presence or absence of the external load.

In this case, the positive electrode insulating tape 90 may be bonded to both the lead part 30B and the positive electrode tab 51 by means of a sticking agent. The sticking agent is not limited to a particular kind, and includes one or more of materials including, without limitation, an acrylic-based sticking agent and a rubber-based sticking agent. Alternatively, the positive electrode insulating tape 90 may be a double-sided sticking tape. It should be understood that the positive electrode insulating tape 90 may be thermal-fusion-bonded to both the lead part 30B and the positive electrode tab 51.

The positive electrode insulating tape 100 is a second insulating member that is disposed inside the outer package film 10, more specifically, is disposed outside the battery device 20.

As illustrated in FIG. 4, the positive electrode insulating tape 100 is disposed between the coupling part C1 and the outer package film 10, and is thus interposed between the coupling part C1 and the outer package film 10. The positive electrode insulating tape 100 therefore insulates the coupling part C1 from its surroundings to thereby prevent a short circuit caused by the coupling part C1.

The positive electrode insulating tape 100 includes a material similar to the material included in the positive electrode insulating tape 90. It should be understood that the material included in the positive electrode insulating tape 100 may be the same as or different from the material included in the positive electrode insulating tape 90.

The positive electrode insulating tape 100 is preferably bonded to both the coupling part C1 and the outer package film 10. A reason for this is that, because the positive electrode insulating tape 100 is fixed to both the coupling part C1 and the outer package film 10, the position of the positive electrode insulating tape 100 is prevented from deviating easily from the original position even if the secondary battery receives an external load. This makes it easier to maintain a state where the positive electrode insulating tape 100 is interposed between the coupling part C1 and the outer package film 10, thus preventing a short circuit caused by the coupling part C1 from occurring easily regardless of presence or absence of the external load.

In this case, the positive electrode insulating tape 100 may be bonded to both the coupling part C1 and the outer package film 10 by means of a sticking agent such as a double-sided sticking tape, or may be thermal-fusion-bonded to both the coupling part C1 and the outer package film 10. Details of the kind of the sticking agent are as described above. It should be understood that the positive electrode insulating tape 100 may be thermal-fusion-bonded to both the coupling part C1 and the outer package film 10.

It should be understood that in a case where the positive electrode insulating tape 100 is a double-sided sticking tape, when the wound body 20Z is placed inside the outer package film 10 in a later-described manufacturing process of the secondary battery, a sticking characteristic of the positive electrode insulating tape 100 can cause difficulty in placing the wound body 20Z inside the outer package film 10.

The negative electrode insulating tape 110 has a configuration similar to the configuration of the positive electrode insulating tape 90 described above. That is, the negative electrode insulating tape 110 is another first insulating member that is disposed inside the outer package film 10, more specifically, is disposed outside the battery device 20.

As illustrated in FIG. 5, the negative electrode insulating tape 110 is disposed to lie along the lower surface N1 between the lead part 40B and a portion of the negative electrode tabs 60, i.e., the negative electrode tab 61 of the negative electrode tabs 61 and 62, and is thus interposed between the coupling part C2 and the battery device 20. The negative electrode insulating tape 110 therefore insulates the coupling part C2 from the battery device 20 (the negative electrode 22) to thereby prevent a short circuit between the coupling part C2 and the battery device 20.

Here, the negative electrode insulating tape 110 is disposed to further lie between the lead part 40B and the battery device 20 along the lower surface N1. The negative electrode insulating tape 110 is thus interposed throughout between the coupling part C2 and the battery device 20, therefore preventing the short circuit between the coupling part C2 and the battery device 20 over a wide range.

Although the negative electrode insulating tape 110 may be disposed to lie along only the lower surface N1, the negative electrode insulating tape 110 is preferably disposed not only to lie along the lower surface N1 but to further lie along the side surface N3 in particular. A reason for this is that this allows a corner of the negative electrode lead 40 (the lead part 40B), i.e., a sharp corner formed by the lower surface N1 and the side surface N3, to be protected by the negative electrode insulating tape 110, and accordingly prevents the negative electrode tab 61 from being damaged by coming into contact with the corner.

The negative electrode insulating tape 110 includes a material similar to the material included in the positive electrode insulating tape 90. It should be understood that the material included in the negative electrode insulating tape 110 may be the same as or different from the material included in the positive electrode insulating tape 90.

It should be understood that the negative electrode insulating tape 110 is preferably bonded to the negative electrode lead 40 (the lead part 40B) and also to the negative electrode tab 61. A reason for this is that, because the negative electrode insulating tape 110 is fixed to both the lead part 40B and the negative electrode tab 61, a short circuit between the coupling part C2 and the battery device 20 is prevented from occurring easily regardless of presence or absence of the external load, for a reason similar to the reason described above in relation to the positive electrode insulating tape 90.

In this case, the negative electrode insulating tape 110 may be bonded to both the lead part 40B and the negative electrode tab 61 by means of a sticking agent. Details of the kind of the sticking agent are as described above. Alternatively, the negative electrode insulating tape 110 may be a double-sided sticking tape. It should be understood that the negative electrode insulating tape 110 may be thermal-fusion-bonded to both the lead part 40B and the negative electrode tab 61.

The negative electrode insulating tape 120 has a configuration similar to the configuration of the positive electrode insulating tape 100 described above. That is, the negative electrode insulating tape 120 is another second insulating member that is disposed inside the outer package film 10, more specifically, is disposed outside the battery device 20.

As illustrated in FIG. 5, the negative electrode insulating tape 120 is disposed between the coupling part C2 and the outer package film 10, and is thus interposed between the coupling part C2 and the outer package film 10. The negative electrode insulating tape 120 therefore insulates the coupling part C2 from its surroundings to thereby prevent a short circuit caused by the coupling part C2.

The negative electrode insulating tape 120 includes a material similar to the material included in the negative electrode insulating tape 110. It should be understood that the material included in the negative electrode insulating tape 120 may be the same as or different from the material included in the negative electrode insulating tape 110.

The negative electrode insulating tape 120 is preferably bonded to both the coupling part C2 and the outer package film 10. A reason for this is that, because the negative electrode insulating tape 120 is fixed to both the coupling part C2 and the outer package film 10, a short circuit caused by the coupling part C2 is prevented from occurring easily regardless of presence or absence of the external load, for a reason similar to the reason described above in relation to the positive electrode insulating tape 100.

In this case, the negative electrode insulating tape 120 may be bonded to both the coupling part C2 and the outer package film 10 by means of a sticking agent such as a double-sided sticking tape, or may be thermal-fusion-bonded to both the coupling part C2 and the outer package film 10. Details of the kind of the sticking agent are as described above.

It should be understood that in a case where the negative electrode insulating tape 120 is a double-sided sticking tape, a sticking characteristic of the negative electrode insulating tape 120 can cause difficulty in placing the wound body 20Z inside the outer package film 10, for a reason similar to the reason described for the case where the positive electrode insulating tape 100 is a double-sided sticking tape.

The auxiliary insulating tape 130 is disposed inside the outer package film 10, more specifically, is disposed inside the battery device 20. The auxiliary insulating tape 130 is interposed between electrically conductive components of the battery device 20 that are adjacent to each other, and thereby insulates such electrically conductive components from each other. Here, the secondary battery includes six auxiliary insulating tapes 130, i.e., auxiliary insulating tapes 131 to 136.

As illustrated in FIG. 4, the auxiliary insulating tapes 131 to 133 insulate the positive electrode tabs 51 and 52 from their surroundings. Specifically, the auxiliary insulating tape 131 is interposed between the positive electrode tab 51 and the negative electrode current collector 22A in the vicinity of an end of the battery device 20 on the inner side of the winding, and extends to lie along the positive electrode tab 51. The auxiliary insulating tape 132 is interposed between the positive electrode current collector 21A and the separator 23 in the vicinity of the end of the battery device 20 on the inner side of the winding, and extends to lie along the positive electrode tab 51. The auxiliary insulating tape 133 is interposed between the positive electrode tab 52 and the separator 23 in the vicinity of an end of the battery device 20 on the outer side of the winding.

As illustrated in FIG. 5, the auxiliary insulating tapes 134 to 136 insulate the negative electrode tabs 61 and 62 from their surroundings. Specifically, the auxiliary insulating tape 134 is interposed between the negative electrode current collector 22A and the separator 23 in the vicinity of the end of the battery device 20 on the inner side of the winding, and extends to lie along the negative electrode tab 61. The auxiliary insulating tape 135 is interposed between the negative electrode tab 61 and the positive electrode current collector 21A in the vicinity of the end of the battery device 20 on the inner side of the winding, and extends to lie along the negative electrode tab 62. The auxiliary insulating tape 136 is interposed between the positive electrode current collector 21A and the separator 23 in the vicinity of the end of the battery device 20 on the outer side of the winding.

Each of the auxiliary insulating tapes 131 to 136 includes one or more of insulating materials including, without limitation, a polymer material. Examples of the polymer material include polyethylene, polyethylene terephthalate, and polyimide.

Upon charging of the secondary battery, in the battery device 20, lithium is extracted from the positive electrode 21, and the extracted lithium is inserted into the negative electrode 22 via the electrolytic solution. Upon discharging of the secondary battery, in the battery device 20, lithium is extracted from the negative electrode 22, and the extracted lithium is inserted into the positive electrode 21 via the electrolytic solution. Upon the charging and discharging, lithium is inserted and extracted in an ionic state.

For describing the process of manufacturing the secondary battery, FIG. 6 illustrates a sectional configuration of the secondary battery in the course of manufacture, and corresponds to FIG. 4. FIG. 7 illustrates the sectional configuration of the secondary battery in the course of manufacture for describing the process of manufacturing the secondary battery, and corresponds to FIG. 5.

In a case of manufacturing the secondary battery, the secondary battery is assembled as described below, with use of the outer package film 10 having the opening 10K illustrated in each of FIGS. 6 and 7. Each of FIGS. 6 and 7 illustrates the outer package film 10 before sealing, i.e., before formation of the seal part S. The opening 10K of the outer package film 10 before the sealing has an opening area greater than the opening area of each of the openings 10K1 and 10K2, to thereby allow the battery device 20 to be put into the outer package film 10.

Here, described is a case where a double-sided sticking tape is used as each of the positive electrode insulating tapes 90 and 100 and the negative electrode insulating tapes 110 and 120.

First, the positive electrode active material is mixed with, on an as-needed basis, a material such as the positive electrode binder or the positive electrode conductor to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on opposite sides of the positive electrode current collector 21A to thereby form the positive electrode active material layers 21B. Thereafter, the positive electrode active material layers 21B may be compression-molded by means of a machine such as a roll pressing machine. In this case, the positive electrode active material layers 21B may be heated. The positive electrode active material layers 21B may be compression-molded multiple times. The positive electrode active material layers 21B are thus formed on the respective opposite sides of the positive electrode current collector 21A. As a result, the positive electrode 21 is fabricated.

The negative electrode active material layers 22B are formed on respective opposite sides of the negative electrode current collector 22A by a procedure similar to the fabrication procedure of the positive electrode 21 described above. Specifically, the negative electrode active material is mixed with, on an as-needed basis, a material such as the negative electrode binder or the negative electrode conductor to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on the opposite sides of the negative electrode current collector 22A to thereby form the negative electrode active material layers 22B. Thereafter, the negative electrode active material layers 22B may be compression-molded. The negative electrode active material layers 22B are thus formed on the respective opposite sides of the negative electrode current collector 22A. As a result, the negative electrode 22 is fabricated.

The electrolyte salt is put into a solvent. The electrolyte salt is thereby dispersed or dissolved in the solvent. As a result, the electrolytic solution is prepared.

First, the positive electrode tabs 51 and 52 are coupled to the positive electrode 21 (the positive electrode current collector 21A) by a method such as a welding method, and the negative electrode tabs 61 and 62 are coupled to the negative electrode 22 (the negative electrode current collector 22A) by a method such as a welding method. Thereafter, the positive electrode 21 and the negative electrode 22 are alternately stacked on each other with the separator 23 interposed therebetween, following which the positive electrode 21, the negative electrode 22, and the separator 23 are wound to thereby fabricate the wound body 20Z. In this case, upon fabrication of the wound body 20Z (upon winding), each of the auxiliary insulating tapes 131 to 136 is inserted at an appropriate position in middle of the winding.

It should be understood that the welding method includes one or more of a laser welding method, a resistance welding method, and any other welding method. Details of the welding method described here apply also to the following.

Thereafter, the one end of the positive electrode tab 51 and the one end of the positive electrode tab 52 are joined to each other by a method such as a welding method, to thereby form the joint part J1. Further, the one end of the negative electrode tab 61 and the one end of the negative electrode tab 62 are joined to each other by a method such as a welding method, to thereby form the joint part J2.

Thereafter, the one end of the positive electrode lead 30 (the lead part 30B) is coupled to the joint part J1 by a method such as a welding method, to thereby form the coupling part C1. Further, the one end of the negative electrode lead 40 (the lead part 40B) is coupled to the joint part J2 by a method such as a welding method, to thereby form the coupling part C2. Thus, the positive electrode wiring line 200 (the positive electrode lead 30 and the positive electrode tabs 51 and 52) and the negative electrode wiring line 300 (the negative electrode lead 40 and the negative electrode tabs 61 and 62) are each coupled to the wound body 20Z.

Thereafter, the wound body 20Z to which the positive electrode wiring line 200 and the negative electrode wiring line 300 are each coupled is placed inside the outer package film 10 through the opening 10K. The wound body 20Z is thereby placed inside the outer package film 10 in a state where the positive electrode wiring line 200 and the negative electrode wiring line 300 are each already coupled to the wound body 20Z. This allows the positive electrode wiring line 200, the negative electrode wiring line 300, and the wound body 20Z to be placed inside the outer package film 10 together.

In this case, the positive electrode tab 51 is bent to lie along the lower surface M1, the side surface M3, and the upper surface M2 of the lead part 30B in this order, and the negative electrode tab 61 is bent to lie along the lower surface N1, the side surface N3, and the upper surface N2 of the lead part 40B in this order.

The positive electrode insulating tape 90 is disposed to lie along the lower surface M1 of the lead part 30B, and is thereby bonded to both the lead part 30B and the positive electrode tab 51. Further, the negative electrode insulating tape 110 is disposed to lie along the lower surface N1 of the lead part 40B, and is thereby bonded to both the lead part 40B and the negative electrode tab 61.

Lastly, the electrolytic solution is injected into the outer package film 10 through the opening 10K, following which portions of the outer package film 10 mutually opposed at the opening 10K are joined to each other by a method such as a thermal fusion bonding method.

In this case, the positive electrode insulating tape 100 is disposed between the coupling part C1 and the outer package film 10, and is thereby bonded to both the coupling part C1 and the outer package film 10. Further, the negative electrode insulating tape 120 is disposed between the coupling part C2 and the outer package film 10, and is thereby bonded to both the coupling part C2 and the outer package film 10.

Further, the positive electrode sealant 70 is interposed between the outer package film 10 and the positive electrode wiring line 200 at the opening 10K1, and the negative electrode sealant 80 is interposed between the outer package film 10 and the negative electrode wiring line 300 at the opening 10K2.

Thus, the opening 10K1 is sealed by means of the positive electrode sealant 70 in a state where the positive electrode wiring line 200 is present at the opening 10K1. In addition, the opening 10K2 is sealed by means of the negative electrode sealant 80 in a state where the negative electrode wiring line 300 is present at the opening 10K2. Further, the wound body 20Z including the positive electrode 21, the negative electrode 22, and the separator 23 is impregnated with the electrolytic solution. As a result, the battery device 20 which is the wound electrode body is fabricated.

Thus, the seal part S is formed while the positive electrode wiring line 200 and the negative electrode wiring line 300 are each led out from the outer package film 10 to the outside. Accordingly, the battery device 20 is sealed inside the outer package film 10. As a result, the secondary battery of the laminated-film type is completed.

According to this secondary battery, the battery device 20 is contained inside the outer package film 10 having flexibility. The positive electrode wiring line 200 (the positive electrode lead 30) extending from the inside to the outside of the outer package film 10 includes the lead part 30B opposed to the battery device 20, and the lead part 30B includes the lower surface M1, the side surface M3, and the upper surface M2. The positive electrode tabs 51 and 52 are disposed inside the outer package film 10. The one end of each of the positive electrode tabs 51 and 52 is coupled to the battery device 20 (the positive electrode 21), and the other end of each of the positive electrode tabs 51 and 52 is coupled to the lead part 30B at the upper surface M2. A portion of each of the positive electrode tabs 51 and 52 is bent to lie along the lower surface M1, the side surface M3, and the upper surface M2 in this order, and the positive electrode insulating tape 90 is disposed to lie along the lower surface M1 between the lead part 30B and the positive electrode tab 51. Accordingly, it is possible to secure higher reliability related to the wiring structure inside the secondary battery for the following reasons.

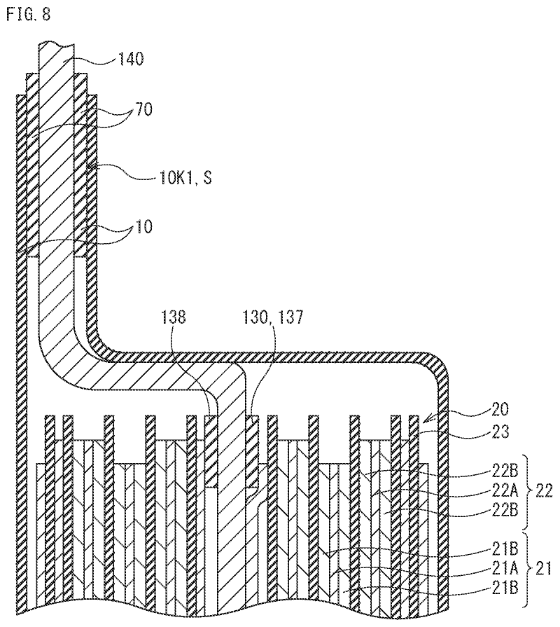

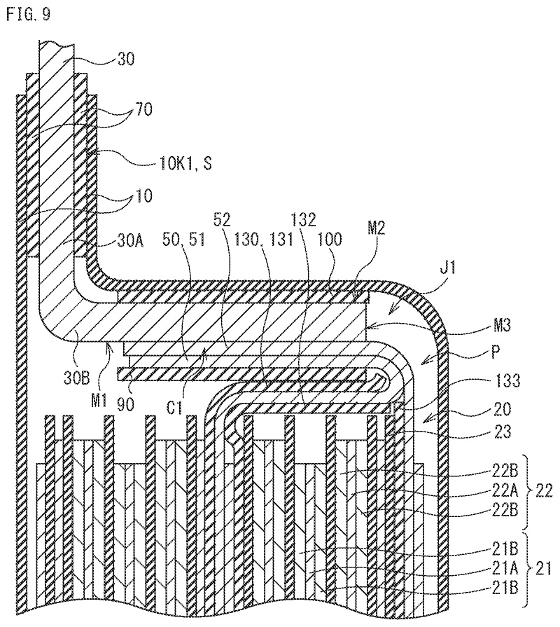

FIG. 8 illustrates a sectional configuration of a secondary battery of a first comparative example, and corresponds to FIG. 4. FIG. 9 illustrates a sectional configuration of a secondary battery of a second comparative example, and corresponds to FIG. 4.

As illustrated in FIG. 8, the secondary battery of the first comparative example has a configuration almost similar to the configuration of the secondary battery of the present embodiment illustrated in FIG. 4, except that the secondary battery of the first comparative example includes a positive electrode lead 140 in place of the positive electrode lead 30 and the positive electrode tabs 50 (i.e., the positive electrode tabs 51 and 52), and includes auxiliary insulating tapes 130 (i.e., auxiliary insulating tapes 137 and 138) in place of the positive electrode insulating tapes 90 and 100, the negative electrode insulating tapes 110 and 120, and the auxiliary insulating tapes 130 (i.e., the auxiliary insulating tapes 131 to 136).

The positive electrode lead 140 extends from the inside of the outer package film 10 to the outside via the seal part S, and is coupled to the positive electrode 21 (the positive electrode current collector 21A). That is, the positive electrode lead 140 serves as both the positive electrode lead 30 and the positive electrode tabs 50. In order to be coupled to the positive electrode 21, the positive electrode lead 140 is bent twice inside the outer package film 10. The positive electrode lead 140 is insulated from the negative electrode 22 (the negative electrode current collector 22A) by means of the auxiliary insulating tapes 136 and 137, and is insulated from its surroundings by means of the positive electrode sealant 70 between the seal part S and the battery device 20.

As illustrated in FIG. 9, the secondary battery of the second comparative example has a configuration similar to the configuration of the secondary battery of the present embodiment illustrated in FIG. 4, except that a coupling scheme between the positive electrode lead 30 (the lead part 30B) and the joint part J1 is different.

The positive electrode tab 51 is bent to lie along only the lower surface M1 in a folded manner. Accordingly, the joint part J1 is coupled to the lower surface M1 of the lead part 30B to thereby form the coupling part C1.

In the secondary battery of the first comparative example, as illustrated in FIG. 8, one positive electrode lead 140 is used as a coupling terminal to be coupled to electronic equipment. In this case, in order to increase the number of external-coupling terminals for the purpose of decreasing an electric resistance (an electric coupling resistance) of the secondary battery (the battery device 20), there is no choice but to increase the number of the positive electrode leads 140.

However, the increase in the number of the positive electrode leads 140 causes an increase in volume occupied by the positive electrode leads 140 inside the outer package film 10. This, in turn, causes an excessive increase in volume loss of the internal space of the outer package film 10, and also complicates the sealing structure of a seal part S1 because it is necessary to seal the outer package film 10 in a state where the plurality of positive electrode leads 140 is led out to the outside. The term “volume loss” refers to a decrease in volume (effective volume) of the internal space of the outer package film 10 available for containing the battery device 20. Accordingly, the energy density per unit volume of the secondary battery markedly decreases due to the excessive increase in volume loss, and stable sealing of the seal part Si becomes difficult due to the complicated sealing structure. This not only results in a decrease in a characteristic such as a battery capacity characteristic but also results in unstable charging and discharging operations of the secondary battery. As a result, it is difficult to secure higher reliability related to the wiring structure inside the secondary battery.

In the secondary battery of the second comparative example, as illustrated in FIG. 9, the positive electrode lead 30 and the positive electrode tabs 50 (the positive electrode tabs 51 and 52) are used as the external-coupling terminals. Thus, the coupling terminal for the electronic equipment, i.e., the positive electrode lead 30, and the coupling terminal for the battery device 20, i.e., the positive electrode tabs 50, are separated from each other and have their respective roles. In this case, in order to increase the number of coupling terminals for the purpose of decreasing an electric coupling resistance, it is not necessary to increase the number of the positive electrode leads 30, and it is sufficient that only the number of the positive electrode tabs 50 is increased. Accordingly, the energy density per unit volume of the secondary battery increases due to avoidance of the excessive increase in volume loss, and stable sealing of the seal part S is achieved easily due to the simple sealing structure.

However, the positive electrode tab 51 is bent to lie along only the lower surface M1 of the lead part 30B in a folded manner. In this case, the positive electrode tab 51 is abruptly bent at a bending part P. In other words, the positive electrode tab 51 is bent at a bending angle that causes the radius of curvature to be markedly small. This lowers physical durability of the positive electrode tab 51. Accordingly, if the secondary battery receives an external load such as vibration or impact, the positive electrode tab 51 is easily damaged at the bending part P due to the external load. The wording “damaged” refers to occurrence of a crack in the positive electrode tab 51 at the bending part P, or even of a breakage of the positive electrode tab 51 at the bending part P in some cases. This causes the charging and discharging operations of the secondary battery to be easily inhibited due to the damage of the positive electrode tab 51. Accordingly, it is difficult to secure higher reliability related to the wiring structure inside the secondary battery.

In contrast, in the secondary battery of the present embodiment, as illustrated in FIG. 4, in a case where the positive electrode lead 30 and the positive electrode tabs 50 (i.e., the positive electrode tabs 51 and 52) are used as the coupling terminals for the purpose of decreasing the electric coupling resistance, the positive electrode tab 51 is bent to lie along the lower surface M1, the side surface M3, and the upper surface M2 of the lead part 30B in this order. In this case, the positive electrode tab 51 is bent mildly at the bending part P. In other words, the positive electrode tab 51 is bent at a bending angle that allows the radius of curvature to be sufficiently large. The physical durability of the positive electrode tab 51 is therefore not lowered but is maintained. Accordingly, the positive electrode tab 51 is prevented from being damaged easily at the bending part P even if the secondary battery receives an external load.

In addition, the positive electrode insulating tape 90 is disposed to lie along the lower surface M1 between the lead part 30B and the positive electrode tab 51. Accordingly, even though the joint part J1 is coupled to the upper surface M2 of the lead part 30B, the lead part 30B is insulated from the battery device 20 (the negative electrode 22) by means of the positive electrode insulating tape 90. This prevents a short circuit between the lead part 30B and the negative electrode 22.

Thus, unlike the secondary batteries of the first and second comparative examples, the secondary battery of the present embodiment makes it possible to secure the energy density per unit area, makes it possible to stably seal the seal part S, and also with the use of the positive electrode lead 30 and the positive electrode tab 51, makes it possible to improve the physical durability of the positive electrode tab 51 and to prevent a short circuit caused by the positive electrode lead 30 (the lead part 30B). Accordingly, stable charging and discharging operations of the secondary battery are secured while a characteristic such as the battery capacity characteristic is improved. As a result, it is possible to secure higher reliability related to the wiring structure inside the secondary battery.

In this case, in the manufacturing process of the secondary battery, the wound body 20Z is placed inside the outer package film 10 in the state where the positive electrode wiring line 200 and the negative electrode wiring line 300 are each already coupled to the wound body 20Z, in particular. This allows the positive electrode wiring line 200, the negative electrode wiring line 300, and the wound body 20Z to be placed inside the outer package film 10 together. Accordingly, it is easy to contain the positive electrode wiring line 200, the negative electrode wiring line 300, and the wound body 20Z inside the outer package film 10. As a result, it is also possible to manufacture the secondary battery easily and stably.

Other than the above, in the secondary battery of the present embodiment, the positive electrode insulating tape 90 may be disposed to further lie between the lead part 30B and the battery device 20. This prevents a short circuit between the coupling part C1 and the battery device 20 over a wide range. Accordingly, it is possible to achieve higher effects.

Moreover, the positive electrode insulating tape 90 may be bonded to both the lead part 30B and the positive electrode tab 51. This allows the positive electrode insulating tape 90 to be fixed to both the lead part 30B and the positive electrode tab 51, and therefore helps to prevent the position of the positive electrode insulating tape 90 from deviating easily from the original position even if the secondary battery receives an external load. As a result, a short circuit between the coupling part C1 and the battery device 20 is prevented regardless of presence or absence of the external load. Accordingly, it is possible to achieve higher effects.

It should be understood that in order to fix the positive electrode insulating tape 90, it is conceivable to bond the positive electrode insulating tape 90 not to the lead part 30B but to the battery device 20. In this case also, the lead part 30B is insulated from the battery device 20 by means of the positive electrode insulating tape 90.

However, bonding the positive electrode insulating tape 90 to the battery device 20 can cause a defect. Specifically, a physical load upon the bonding of the positive electrode insulating tape 90 causes a shift in winding of the battery device 20 to occur easily. This causes the charging and discharging reactions in the battery device 20 to be ununiform easily. In addition, the surface of the battery device 20 on a side opposed to the lead part 30B has protrusions and recesses due to a difference in height among the positive electrode 21, the negative electrode 22, and the separator 23. The presence of such protrusions and recesses causes unevenness in bonding of the positive electrode insulating tape 90 to occur easily. In addition, in a case where the positive electrode insulating tape 90 is a bonding tape, the charging and discharging operations are inhibited easily due to entry of the bonding agent of the bonding tape into the battery device 20.

Accordingly, in order to stabilize the charging and discharging operations of the secondary battery, the positive electrode insulating tape 90 is preferably bonded not to the battery device 20 but to the lead part 30B.

Moreover, the positive electrode insulating tape 90 may be disposed not only to lie along the lower surface M1 but to further lie along the side surface M3. This helps to prevent the positive electrode tab 51 from being damaged easily. Accordingly, it is possible to achieve higher effects.

Moreover, the positive electrode insulating tape 100 may be disposed between the coupling part C1 and the outer package film 10. This prevents a short circuit caused by the coupling part C1 also by means of the positive electrode insulating tape 100. Accordingly, it is possible to achieve higher effects. In this case, the positive electrode insulating tape 100 may be bonded to both the coupling part C1 and the outer package film 10. This further prevents the short circuit caused by the coupling part C1 regardless of presence or absence of the external load. Accordingly, it is possible to achieve further higher effects.

Moreover, the battery device 20 may be a wound electrode body, and the positive electrode 21 and the negative electrode 22 may therefore be wound with the separator 23 interposed therebetween. This makes it easier to decrease the electric coupling resistance of the battery device 20 only by increasing the number of the positive electrode tabs 50 up to a freely chosen number that is two or greater. Accordingly, it is possible to achieve higher effects. In this case, the positive electrode tabs 51 and 52 may be coupled to the respective exposed parts 21AH of the positive electrode current collector 21A. This further decreases the electric coupling resistance, as compared with a case where each of the positive electrode tabs 51 and 52 is coupled to the positive electrode active material layer 21B. Accordingly, it is possible to achieve further higher effects.

Moreover, the secondary battery may include a lithium-ion secondary battery. This makes it possible to stably obtain a sufficient battery capacity by utilizing insertion and extraction of lithium. Accordingly, it is possible to achieve higher effects.

Here, the description has been given of the action and effects based on the respective configurations of the positive electrode wiring line 200 (the positive electrode lead 30 (the lead part 30B) and the positive electrode tabs 50 (the positive electrode tabs 51 and 52)) and the positive electrode insulating tape 90 with reference to FIGS. 4, 8, and 9. However, the negative electrode wiring line 300 (the negative electrode lead 40 (the lead part 40B) and the negative electrode tabs 60 (the negative electrode tabs 61 and 62)) and the negative electrode insulating tape 110 have configurations similar to those of the positive electrode wiring line 200 and the positive electrode insulating tape 90, respectively. Accordingly, it is possible to achieve similar action and effects also on the basis of the respective configurations of the negative electrode wiring line 300 and the negative electrode insulating tape 110.

Next, modifications of the foregoing secondary battery will be described. The configuration of the secondary battery is appropriately modifiable, as will be described below. It should be understood that any two or more of the following series of modifications may be combined.

### Modification 1

In FIGS. 4 and 5, the secondary battery includes both the positive electrode insulating tape 90 and the negative electrode insulating tape 110. However, the secondary battery may include only one of the positive electrode insulating tape 90 and the negative electrode insulating tape 110. Even in such a case, a short circuit caused by the coupling part C1 or the coupling part C2 is prevented, as compared with a case where the secondary battery includes neither the positive electrode insulating tape 90 nor the negative electrode insulating tape 110. Accordingly, it is possible to achieve similar effects.

However, in order to sufficiently prevent the short circuit and to thereby achieve more stable charging and discharging operations of the secondary battery, the secondary battery preferably includes both the positive electrode insulating tape 90 and the negative electrode insulating tape 110.

### Modification 2

In FIG. 4, the positive electrode insulating tape 90 is disposed from between the lead part 30B and the positive electrode tab 51 to between the lead part 30B and the battery device 20, lying along the lower surface M1. However, as long as the positive electrode insulating tape 90 is disposed to lie along the lower surface M1, the range to dispose the positive electrode insulating tape 90 is not particularly limited. Even in such a case, the coupling part C1 is insulated from its surroundings by means of the positive electrode insulating tape 90. Accordingly, it is possible to achieve similar effects. However, in order to sufficiently insulate the coupling part C1 from its surroundings over a wide range, the range to dispose the positive electrode insulating tape 90 is preferably as wide as possible.

The description above related to the positive electrode insulating tape 90 is similarly applicable to the negative electrode insulating tape 110 illustrated in FIG. 5. That is, the range to dispose the negative electrode insulating tape 110 is not particularly limited as long as the negative electrode insulating tape 110 is disposed to lie along the lower surface N1.

### Modification 3

In FIG. 4, the positive electrode insulating tape 90 is bonded to both the lead part 30B and the positive electrode tab 51. However, the positive electrode insulating tape 90 may be bonded to only one of the lead part 30B and the positive electrode tab 51. Even in such a case, the positive electrode insulating tape 90 is fixed to the lead part 30B or the positive electrode tab 51. Accordingly, it is possible to achieve similar effects. However, in order to sufficiently fix the positive electrode insulating tape 90, the positive electrode insulating tape 90 is preferably bonded to both the lead part 30B and the positive electrode tab 51.

The description above related to the positive electrode insulating tape 90 is similarly applicable to the negative electrode insulating tape 110 illustrated in FIG. 5. That is, the negative electrode insulating tape 110 may be bonded to only one of the lead part 40B and the negative electrode tab 61.

### Modification 4

In FIG. 4, the secondary battery includes both the positive electrode insulating tape 100 and the negative electrode insulating tape 120. However, the secondary battery may include only one of the positive electrode insulating tape 100 and the negative electrode insulating tape 120. Even in such a case, a short circuit caused by the coupling part C1 or the coupling part C2 is prevented, as compared with a case where the secondary battery includes neither the positive electrode insulating tape 100 nor the negative electrode insulating tape 120. Accordingly, it is possible to achieve similar effects.

However, in order to sufficiently prevent the short circuit and to thereby achieve more stable charging and discharging operations of the secondary battery, the secondary battery preferably includes both the positive electrode insulating tape 100 and the negative electrode insulating tape 120.

It should be understood that the secondary battery may include neither the positive electrode insulating tape 100 nor the negative electrode insulating tape 120. Even in such a case, as long as the secondary battery includes the positive electrode insulating tape 90, the negative electrode insulating tape 110, or both, the short circuit between the coupling part C1 or the coupling part C2 and the battery device 20 is prevented as described above. As a result, it is possible to achieve similar effects.

However, in order to sufficiently prevent the short circuit, the secondary battery preferably includes the positive electrode insulating tape 100, the negative electrode insulating tape 120, or both.

### Modification 5

In FIG. 4, the positive electrode insulating tape 100 is bonded to both the coupling part C1 and the outer package film 10. However, the positive electrode insulating tape 100 may be bonded to only one of the coupling part C1 and the outer package film 10. Even in such a case, the positive electrode insulating tape 100 is fixed to the coupling part C1 or the outer package film 10. Accordingly, it is possible to achieve similar effects. However, in order to sufficiently fix the positive electrode insulating tape 100, the positive electrode insulating tape 100 is preferably bonded to both the coupling part C1 and the outer package film 10.

The description above related to the positive electrode insulating tape 100 is similarly applicable to the negative electrode insulating tape 120 illustrated in FIG. 5. That is, the negative electrode insulating tape 120 may be bonded to only one of the coupling part C2 and the outer package film 10.

### Modification 6

In FIG. 4, the number of the positive electrode tabs 50 is two, i.e., the positive electrode tabs 51 and 52 are provided; in FIG. 5, the number of the negative electrode tabs 60 is two, i.e., the negative electrode tabs 61 and 62 are provided. However, the number of the positive electrode tabs 50 is not particularly limited as long as it is two or more, and may therefore be three or more. In addition, the number of the negative electrode tabs 60 is not particularly limited as long as it is two or more, and may therefore be three or more. In such cases also, it is possible to achieve similar effects.

In such a case, in particular, the greater the number of the positive electrode tabs 50 is, the more the electric resistance (the electric coupling resistance) of the secondary battery (the battery device 20) decreases. Accordingly, the greater number of the positive electrode tabs 50 makes it possible to achieve further higher effects. The effects derived from the decrease in the electric resistance of the secondary battery (the battery device 20) with increasing number of electrode tabs are similarly achievable also in relation to an increase in the number of the negative electrode tabs 60.

### Modification 7

In FIG. 4, the positive electrode wiring line 200 includes the positive electrode lead 30 and the positive electrode tabs 50, and the positive electrode lead 30 and each of the positive electrode tabs 50 are coupled to each other. In other words, the positive electrode wiring line 200 includes two kinds of members that are physically separated from each other (i.e., the positive electrode lead 30 and the positive electrode tabs 50).

However, the positive electrode wiring line 200 may include one kind (one piece) of member in which the positive electrode lead 30 and the positive electrode tabs 50 are integrated together. That is, the positive electrode wiring line 200 may include a member having one end which includes only one part, and another end which is branched into two or more parts. In such a case also, a short circuit is prevented by means of the positive electrode insulating tape 90. Accordingly, it is possible to achieve similar effects.

Modification 7 described above is applicable also to the negative electrode wiring line 300 illustrated in FIG. 5. That is, the negative electrode wiring line 300 may include one piece of member in which the negative electrode lead 40 and the negative electrode tabs 60 are integrated together. In such a case also, a short circuit is prevented by means of the negative electrode insulating tape 110. Accordingly, it is possible to achieve similar effects.

### Modification 8

In FIG. 4, the other end of the positive electrode tab 51 and the other end of the positive electrode tab 52 are joined to each other by a method such as a welding method to thereby form the joint part J1. However, because it suffices that the positive electrode tabs 51 and 52 are in contact with each other, the positive electrode tabs 51 and 52 may be merely stacked on each other rather than being joined to each other by a method such as a welding method. In such a case also, the positive electrode tabs 51 and 52 are coupled to the lead part 30B. Accordingly, it is possible to achieve similar effects.

Modification 8 described above is applicable also to the negative electrode tabs 61 and 62 illustrated in FIG. 5. That is, the negative electrode tabs 61 and 62 may be merely stacked on each other rather than forming the joint part J2. In such a case also, the negative electrode tabs 61 and 62 are coupled to the lead part 40B. Accordingly, it is possible to achieve similar effects.

### Modification 9

The separator 23 which is a porous film is used. However, although not specifically illustrated here, a separator of a stacked type including a polymer compound layer may be used instead of the separator 23 which is the porous film.

Specifically, the separator of the stacked type includes a base layer which is the above-described porous film, and a polymer compound layer provided on one side or each of opposite sides of the base layer. A reason for this is that adherence of the separator to both the positive electrode 21 and the negative electrode 22 improves to suppress the occurrence of misalignment of the battery device 20. This helps to prevent the secondary battery from easily swelling even if, for example, a decomposition reaction of the electrolytic solution occurs. The polymer compound layer includes a polymer compound such as polyvinylidene difluoride. A reason for this is that such a polymer compound has superior physical strength and is electrochemically stable.

It should be understood that the base layer, the polymer compound layer, or both may include one or more kinds of particles including, for example, inorganic particles and resin particles. A reason for this is that such particles dissipate heat upon heat generation by the secondary battery, and this improves heat resistance and safety of the secondary battery. The inorganic particles are not particularly limited in kind, and examples thereof include particles of the following materials: aluminum oxide (alumina), aluminum nitride, boehmite, silicon oxide (silica), titanium oxide (titania), magnesium oxide (magnesia), and zirconium oxide (zirconia).

In a case of fabricating the separator of the stacked type, a precursor solution including, without limitation, the polymer compound and an organic solvent is prepared, following which the precursor solution is applied on one side or each of opposite sides of the base layer.

In the case where the separator of the stacked type is used also, lithium is movable between the positive electrode 21 and the negative electrode 22. Accordingly, it is possible to achieve similar effects.

### Modification 10

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution including, without limitation, the electrolytic solution, the polymer compound, and an organic solvent is prepared, following which the precursor solution is applied on one side or opposite sides of each of the positive electrode 21 and the negative electrode 22.

In the case where the electrolyte layer is used also, lithium is movable between the positive electrode 21 and the negative electrode 22 via the electrolyte layer. Accordingly, it is possible to achieve similar effects.

### Modification 11

In FIG. 4, the lead part 30A extends in the direction intersecting with the extending direction of the lead part 30B, and the positive electrode lead 30 is therefore bent. However, although not specifically illustrated here, the lead part 30A may extend in a direction similar to the extending direction of the lead part 30B. The positive electrode lead 30 may therefore extend in one direction (the horizontal direction in FIG. 4) rather than being bent, and the lead part 30A may therefore be led out from the outer package film 10 to the outside via the opening 10K1 provided in the extending direction of the positive electrode lead 30. In such a case also, the positive electrode tabs 51 and 52 are coupled to the lead part 30B. Accordingly, it is possible to achieve similar effects.

However, in order to allow for easy coupling of the secondary battery to electronic equipment, the lead part 30A preferably extends in the direction intersecting with the extending direction of the lead part 30B.

Modification 11 described above is applicable also to the negative electrode lead 40 (the lead parts 40A and 40B) illustrated in FIG. 5. That is, the lead part 40A may extend in a direction similar to the extending direction of the lead part 40B, and the negative electrode lead 40 therefore needs not to be bent. In such a case also, the negative electrode tabs 61 and 62 are coupled to the lead part 40B. Accordingly, it is possible to achieve similar effects.

### Modification 12

In FIG. 4, the positive electrode tabs 50 and the positive electrode current collector 21A are respective members separated from each other. However, the positive electrode tabs 50 and the positive electrode current collector 21A may be integrated with each other. In this case, in a process of forming the positive electrode current collector 21A by means of a punching process on a metal foil, the metal foil may be punched into a configuration in which the positive electrode tabs 50 and the positive electrode current collector 21A are integrated with each other. It is thereby possible to form the positive electrode current collector 21A integrated with the positive electrode tabs 50. In such a case also, the positive electrode tabs 50 are coupled to the lead part 30B. Accordingly, it is possible to achieve similar effects.

Modification 12 described above is applicable also to the negative electrode tabs 60 and the negative electrode current collector 22A illustrated in FIG. 5. That is, the negative electrode tabs 60 and the negative electrode current collector 22A may be integrated with each other. In such a case also, the negative electrode tabs 60 are coupled to the lead part 40B. Accordingly, it is possible to achieve similar effects.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. It should be understood that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some application examples of the secondary battery will now be described in detail. The configurations of the application examples described below are merely examples, and are appropriately modifiable. The secondary battery to be used in the following application examples is not limited to a particular kind, and may therefore be of a laminated-film type or a cylindrical type.

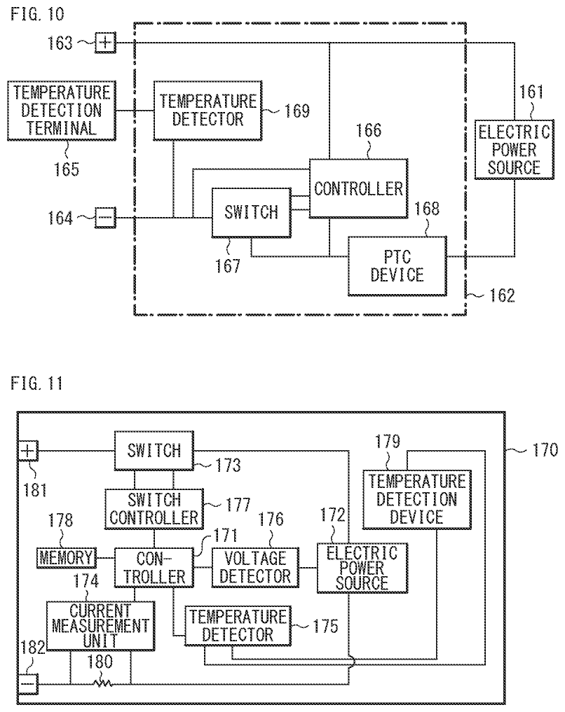

FIG. 10 illustrates a block configuration of a battery pack including a single battery. The battery pack described here is a simple battery pack (a so-called soft pack) including one secondary battery, and is to be mounted on, for example, electronic equipment typified by a smartphone.

As illustrated in FIG. 10, the battery pack includes an electric power source 161 and a circuit board 162. The circuit board 162 is coupled to the electric power source 161, and includes a positive electrode terminal 163, a negative electrode terminal 164, and a temperature detection terminal (a so-called T terminal) 165.

The electric power source 161 includes one secondary battery. The secondary battery has a positive electrode lead coupled to the positive electrode terminal 163 and a negative electrode lead coupled to the negative electrode terminal 164. The electric power source 161 is couplable to outside via the positive electrode terminal 163 and the negative electrode terminal 164, and is thus chargeable and dischargeable via the positive electrode terminal 163 and the negative electrode terminal 164. The circuit board 162 includes a controller 166, a switch 167, a PTC device 168, and a temperature detector 169. However, the PTC device 68 may be omitted.

The controller 166 includes, for example, a central processing unit (CPU) and a memory, and controls an overall operation of the battery pack. The controller 166 detects and controls a use state of the electric power source 161 on an as-needed basis.

If a battery voltage of the electric power source 161 (the secondary battery) reaches an overcharge detection voltage or an overdischarge detection voltage, the controller 166 turns off the switch 167. This prevents a charging current from flowing into a current path of the electric power source 161. In addition, if a large current flows upon charging or discharging, the controller 166 turns off the switch 167 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 167 includes, for example, a charge control switch, a discharge control switch, a charging diode, and a discharging diode. The switch 167 performs switching between coupling and decoupling between the electric power source 161 and external equipment in accordance with an instruction from the controller 166. The switch 167 includes, for example, a metal-oxide-semiconductor field-effect transistor (MOSFET) including a metal-oxide semiconductor. The charging and discharging currents are detected on the basis of an ON-resistance of the switch 167.

The temperature detector 169 includes a temperature detection device such as a thermistor. The temperature detector 169 measures a temperature of the electric power source 161 using the temperature detection terminal 165, and outputs a result of the temperature measurement to the controller 166. The result of the temperature measurement to be obtained by the temperature detector 169 is used, for example, in a case where the controller 166 performs charge/discharge control upon abnormal heat generation or in a case where the controller 166 performs a correction process upon calculating a remaining capacity.

FIG. 11 illustrates a block configuration of a battery pack including an assembled battery. In the following description, reference will be made as necessary to the components of the battery pack including the single battery (see FIG. 10).

As illustrated in FIG. 11, the battery pack includes a positive electrode terminal 181 and a negative electrode terminal 182. Specifically, the battery pack includes, inside a housing 170, the following components: a controller 171, an electric power source 172, a switch 173, a current measurement unit 174, a temperature detector 175, a voltage detector 176, a switch controller 177, a memory 178, a temperature detection device 179, and a current detection resistor 180.

The electric power source 172 includes an assembled battery in which two or more secondary batteries are coupled to each other, and a type of the coupling of the two or more secondary batteries is not particularly limited. Accordingly, the coupling scheme may be in series, in parallel, or of a mixed type of both. For example, the electric power source 172 includes six secondary batteries coupled to each other in two parallel and three series.

Configurations of the controller 171, the switch 173, the temperature detector 175, and the temperature detection device 179 are similar to those of the controller 166, the switch 167, and the temperature detector 169 (the temperature detection device). The current measurement unit 174 measures a current using the current detection resistor 180, and outputs a result of the measurement of the current to the controller 171. The voltage detector 176 measures a battery voltage of the electric power source 172 (the secondary battery) and provides the controller 171 with a result of the measurement of the voltage that has been subjected to analog-to-digital conversion.

The switch controller 177 controls an operation of the switch 173 in response to signals supplied by the current measurement unit 174 and the voltage detector 176. If a battery voltage reaches an overcharge detection voltage or an overdischarge detection voltage, the switch controller 177 turns off the switch 173 (the charge control switch). This prevents a charging current from flowing into a current path of the electric power source 172. This enables the electric power source 172 to perform only discharging via the discharging diode, or only charging via the charging diode. In addition, if a large current flows upon charging or discharging, the switch controller 177 blocks the charging current or the discharging current.

The switch controller 177 may be omitted and the controller 171 may thus also serve as the switch controller 177. The overcharge detection voltage and the overdischarge detection voltage are not particularly limited, and are similar to those described above in relation to the battery pack including the single battery.

The memory 178 includes, for example, an electrically erasable programmable read-only memory (EEPROM) which is a non-volatile memory, and the memory 178 stores, for example, a numeric value calculated by the controller 171 and data (e.g., an initial internal resistance, a full charge capacity, and a remaining capacity) of the secondary battery measured in the manufacturing process.

The positive electrode terminal 181 and the negative electrode terminal 182 are terminals coupled to, for example, external equipment that operates using the battery pack, such as a laptop personal computer, or external equipment that is used to charge the battery pack, such as a charger. The electric power source 172 (the secondary battery) is chargeable and dischargeable via the positive electrode terminal 181 and the negative electrode terminal 182.

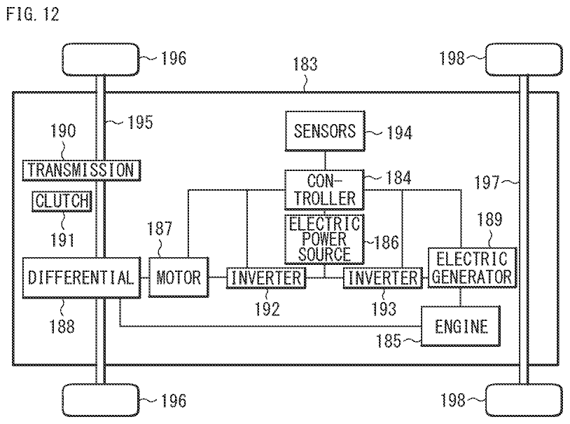

FIG. 12 illustrates a block configuration of a hybrid automobile which is an example of the electric vehicle. As illustrated in FIG. 12, the electric vehicle includes, inside a housing 183, the following components: a controller 184, an engine 185, an electric power source 186, a motor 187, a differential 188, an electric generator 189, a transmission 190, a clutch 191, inverters 192 and 193, and sensors 194. The electric vehicle also includes a front wheel drive shaft 195, a pair of front wheels 196, a rear wheel drive shaft 197, and a pair of rear wheels 198. The front wheel drive shaft 195 and the pair of front wheels 196 are coupled to the differential 188 and the transmission 190.

The electric vehicle is configured to travel by using one of the engine 185 and the motor 187 as a driving source. The engine 185 is a major power source, such as a gasoline engine. In a case where the engine 185 is used as a power source, a driving force (a rotational force) of the engine 185 is transmitted to the front wheels 196 and the rear wheels 198 via the differential 188, the transmission 190, and the clutch 191, which are driving parts. It should be understood that the rotational force of the engine 185 is transmitted to the electric generator 189, and the electric generator 189 thus generates alternating-current power by utilizing the rotational force. In addition, the alternating-current power is converted into direct-current power via the inverter 193, and the direct-current power is thus accumulated in the electric power source 186. In contrast, in a case where the motor 187 which is a converter is used as a power source, electric power (direct-current power) supplied from the electric power source 186 is converted into alternating-current power via the inverter 192. Thus, the motor 187 is driven by utilizing the alternating-current power. A driving force (a rotational force) converted from the electric power by the motor 187 is transmitted to the front wheels 196 and the rear wheels 198 via the differential 188, the transmission 190, and the clutch 191, which are the driving parts.

When the electric vehicle is decelerated by means of a brake mechanism, a resistance force at the time of the deceleration is transmitted as a rotational force to the motor 187. Thus, the motor 187 may generate alternating-current power by utilizing the rotational force. The alternating-current power is converted into direct-current power via the inverter 192, and direct-current regenerative power is thus accumulated in the electric power source 186.

The controller 184 includes, for example, a CPU, and controls an overall operation of the electric vehicle. The electric power source 186 includes one or more secondary batteries and is coupled to an external electric power source. In this case, the electric power source 186 may be supplied with electric power from the external electric power source and thereby accumulate the electric power. The sensors 194 are used to control the number of revolutions of the engine 185 and to control an angle of a throttle valve (a throttle angle). The sensors 194 include one or more of sensors including, without limitation, a speed sensor, an acceleration sensor, and an engine speed sensor.

The case where the electric vehicle is a hybrid automobile has been described as an example; however, the electric vehicle may be a vehicle that operates using only the electric power source 186 and the motor 187 and not using the engine 185, such as an electric automobile.

Although not specifically illustrated here, other application examples are also conceivable as application examples of the secondary battery.

Specifically, the secondary battery is applicable to an electric power storage system. The electric power storage system includes, inside a building such as a residential house or a commercial building, the following components: a controller, an electric power source including one or more secondary batteries, a smart meter, and a power hub.

The electric power source is coupled to electric equipment such as a refrigerator installed inside the building, and is couplable to an electric vehicle such as a hybrid automobile stopped outside the building. Further, the electric power source is coupled, via the power hub, to a home power generator such as a solar power generator installed at the building, and is also coupled, via the smart meter and the power hub, to a centralized power system of an external power station such as a thermal power station.

Alternatively, the secondary battery is applicable to an electric power tool such as an electric drill or an electric saw. The electric power tool includes, inside a housing to which a movable part such as a drilling part or a saw blade part is attached, the following components: a controller, and an electric power source including one or more secondary batteries.

Although the technology has been described above with reference to some embodiments and examples, the configuration of the technology is not limited to those described with reference to the embodiments and examples above, and is therefore modifiable in a variety of ways.

Specifically, although the description above relates to a case where the battery device has a wound-type device structure (the wound electrode body), the device structure of the battery device is not particularly limited, and therefore may be any other device structure such as a stacked-type device structure in which the electrodes (the positive electrode and the negative electrode) are stacked (a stacked electrode body), or a zigzag-folded-type device structure in which the electrodes (the positive electrode and the negative electrode) are folded in a zigzag manner.

Further, although the description above relates to a case where the electrode reactant is lithium, the electrode reactant is not particularly limited. Specifically, as described above, the electrode reactant may be another alkali metal such as sodium or potassium, or may be an alkaline earth metal such as beryllium, magnesium, or calcium. Other than the above, the electrode reactant may be another light metal such as aluminum.

The effects described herein are mere examples, and effects of the present technology are therefore not limited to those described herein. Accordingly, the present technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having flexibility;
a battery device accommodated inside the outer package member;
a first wiring member that extends from an inside to an outside of the outer package member and includes an opposed part opposing to the battery device, wherein the opposed part includes an opposed surface, an opposite surface, and a side surface, and wherein the opposed surface is opposed to the battery device, the opposite surface is provided on an opposite side to the opposed surface, and the side surface is coupled to the opposed surface and the opposite surface;
second wiring members disposed inside the outer package member, wherein each of the second wiring members has a first end coupled to the battery device and a second end coupled to the opposed part at the opposite surface, and wherein a portion of each of the second wiring members is bent to lie along the opposed surface, the side surface, and the opposite surface in this order; and
a first insulating member disposed to lie along the opposed surface between the opposed part and a portion of the second wiring members.

2. The secondary battery according to claim 1, wherein the first insulating member is disposed to further lie between the opposed part and the battery device.

3. The secondary battery according to claim 1, wherein the first insulating member is bonded to the opposed part, the portion of the second wiring members, or both.

4. The secondary battery according to claim 2, wherein the first insulating member is bonded to the opposed part, the portion of the second wiring members, or both.

5. The secondary battery according to claim 1, wherein the first insulating member is disposed to further lie along the side surface.

6. The secondary battery according to claim 2, wherein the first insulating member is disposed to further lie along the side surface.

7. The secondary battery according to claim 3, wherein the first insulating member is disposed to further lie along the side surface.

8. The secondary battery according to claim 1, further comprising a second insulating member disposed between the second end of each of the second wiring members and the outer package member.

9. The secondary battery according to claim 2, further comprising a second insulating member disposed between the second end of each of the second wiring members and the outer package member.

10. The secondary battery according to claim 3, further comprising a second insulating member disposed between the second end of each of the second wiring members and the outer package member.

11. The secondary battery according to claim 5, further comprising a second insulating member disposed between the second end of each of the second wiring members and the outer package member.

12. The secondary battery according to claim 8, wherein the second insulating member is bonded to the second end of each of the second wiring members, the outer package member, or both.

13. The secondary battery according to claim 1, wherein the battery device includes an electrode and a separator, and the electrode is wound with the separator.

14. The secondary battery according to claim 13, wherein
the electrode includes a current collector and an active material layer provided on the current collector,
the current collector includes respective exposed parts at an end on an inner side of winding and an end on an outer side of the winding, the exposed parts being provided with no active material layer, and
the second wiring members are coupled to the exposed parts.

15. The secondary battery according to claim 1, wherein the secondary battery includes a lithium-ion secondary battery.
